(19) United States
(12) Patent Application Publication
(10) Pub. No.: US 2025/0104995 A1
(43) Pub. Date: Mar. 27, 2025

(54) PRODUCTION METHOD FOR UV LIGHT-EMITTING BODY, UV LIGHT-EMITTING BODY, AND UV LIGHT SOURCE

(71) Applicant: HAMAMATSU PHOTONICS K.K., Hamamatsu-shi, Shizuoka (JP)

(72) Inventors: Kohei IKEDA, Hamamatsu-shi, Shizoka (JP); Norio ICHIKAWA, Hamamatsu-shi, Shizoka (JP)

(73) Assignee: HAMAMATSU PHOTONICS K.K., Hamamatsu-shi, Shizuoka (JP)

(21) Appl. No.: 18/724,756

(22) PCT Filed: Dec. 7, 2022
(86) PCT No.: PCT/JP2022/045119

§ 371 Date: Jun. 27, 2024

(30) Foreign Application Priority Data
Jan. 4, 2022 (JP) 2022-000279

(51) Int. Cl. H01J 63/06; C09K 11/77; H01J 65/00

(52) U.S. Cl. CPC H01J 63/06; C09K 11/7777; H01J 65/00

(57) ABSTRACT

A production method for an ultraviolet light-emitting body containing Sc:YPO₄ crystals, the method containing: subjecting a raw material to a hydrothermal reaction to obtain a precursor, the raw material containing a Sc source, a Y source, and a PO₄ source; and firing the precursor.

### TECHNICAL FIELD

The present invention relates to a production method for an ultraviolet light-emitting body, an ultraviolet light-emitting body, and an ultraviolet light source.

### BACKGROUND ART

Since the establishment of the Minamata Convention on Mercury, demand for alternative products to mercury lamps has increased. For example, Patent Literature 1 describes a phosphor represented by (Lu,Y,Al,Ga)₁₋ₓPO₄:Scₓ (wherein 0.005≤x≤0.80) as a phosphor that emits ultraviolet light when excited by irradiation with vacuum ultraviolet light or electron beams. Further, Patent Literature 1 describes a method (so-called solid-phase method) in which oxides of constituent elements constituting a phosphor are used as raw materials, and the raw materials are mixed in a stoichiometric ratio to achieve a desired composition of the phosphor and are fired at high temperature in an atmospheric atmosphere, as an example of a method for producing such an ultraviolet light-emitting phosphor.

Furthermore, Patent Literature 2 describes an ultraviolet light-emitting phosphor that contains ScₓY₁₋ₓPO₄ crystals (wherein 0<x<1) and generates ultraviolet light having a second wavelength longer than a first wavelength upon receiving ultraviolet light having the first wavelength. Patent Literature 2 describes a production method containing a first step of producing a mixture containing an oxide of yttrium (Y), an oxide of scandium (Sc), phosphoric acid or a phosphoric acid compound, and a liquid, a second step of evaporating the liquid, and a third step of firing the mixture, as a production method for the ultraviolet light-emitting phosphor, and that the emission intensity of ultraviolet light can be increased by such a liquid phase method (also, referred to as a solution method), compared to a method (a solid phase method) in which powders of an oxide of Y, an oxide of Sc, and phosphoric acid (or a phosphoric acid compound) are simply mixed and fired.

### CITATION LIST

### Patent Literature

[Patent Literature 1] PCT International Publication No. WO2018/235723
[Patent Literature 2] Japanese Unexamined Patent Publication No. 2020-97639

### SUMMARY OF INVENTION

### Technical Problem

According to studies by the inventors, in an ultraviolet light-emitting body containing Sc:YPO₄ crystals, it may be desirable to reduce a particle size of particles of the Sc:YPO₄ crystals. However, there are limits to reducing the particle size of Sc:YPO₄ crystal particles using a conventional liquid phase method or solid phase method.

Accordingly, one aspect of the present invention aims to produce an ultraviolet light-emitting body containing Sc:YPO₄ crystal particles having a smaller average particle size than the crystal particles obtained by a liquid phase method or a solid phase method.

### Solution to Problem

As a result of extensive research, the inventors have found that an average particle size of Sc:YPO₄ crystal particles can be reduced by using a hydrothermal reaction when producing an ultraviolet light-emitting body containing Sc:YPO₄ crystal particles, compared to average particle sizes obtained by using a liquid phase method and a solid phase method. In some aspects, the present invention provides the following [1] to [7].
[1] A production method for an ultraviolet light-emitting body containing Sc:YPO₄ crystal particles, the method containing: subjecting a raw material to a hydrothermal reaction to obtain a precursor, the raw material containing a Sc source, a Y source, and a PO₄ source; and firing the precursor.
[2] The production method according to [1], wherein the raw material further contains Li₂CO₃.
[3] The production method according to [2], wherein a blending amount of the Li₂CO₃ is 0.36 parts by mass or more with respect to 100 parts by mass of a sum of a theoretical yield of the Sc:YPO₄ and the blending amount of the Li₂CO₃.
[4] The production method according to any one of [1] to [3], wherein a heating temperature during the hydrothermal reaction of the raw material is 150° C. or higher.
[5] An ultraviolet light-emitting body containing Sc:YPO₄ crystal particles containing Li, wherein an average particle size of the Sc:YPO₄ crystal particles is 5.10 μm or less.
[6] An ultraviolet light source containing: the ultraviolet light-emitting body according to [5]; and a light source configured to irradiate the ultraviolet light-emitting body with excitation light having a shorter wavelength than a wavelength of light emitted by the ultraviolet light-emitting body.
[7] An ultraviolet light source containing: the ultraviolet light-emitting body according to [5]; and an electron source configured to irradiate the ultraviolet light-emitting body with an electron beam.

### Advantageous Effects of Invention

According to one aspect of the present invention, it is possible to produce an ultraviolet light-emitting body containing Sc:YPO₄ crystal particles having a smaller average particle size than the crystal particles obtained by a liquid phase method or a solid phase method.

### BRIEF DESCRIPTION OF DRAWINGS

FIG. 1 is a schematic view showing an internal configuration of an electron beam excitation type ultraviolet light source according to an embodiment.

FIG. 2 is a cross-sectional view showing a configuration of an ultraviolet light generation target.

FIG. 3 is a cross-sectional view showing a configuration of a photo-excitation type ultraviolet light source.

FIG. 4 is a cross-sectional view of the ultraviolet light source shown in FIG. 3 along line IV-IV.

FIG. 5 is a cross-sectional view showing a configuration of another photo-excitation type ultraviolet light source.

FIG. 6 is a cross-sectional view of the ultraviolet light source shown in FIG. 5 along line VI-VI.

FIG. 7 is a cross-sectional view showing a configuration of yet another photo-excitation type ultraviolet light source.

FIG. 8 is a cross-sectional view of the ultraviolet light source shown in FIG. 7 along line VIII-VIII.

FIG. 9 is a SEM photograph of a surface of an ultraviolet light-emitting body produced in Production example 1.

FIG. 10 is a photograph (a) of a measurement sample using the ultraviolet light-emitting body produced in Production example 1 before an adhesion test, a photograph (b) after the adhesion test, and a binarized image (c) of the photograph after the adhesion test.

FIG. 11 is a photograph (a) of a measurement sample using an ultraviolet light-emitting body produced in Production example 2 before an adhesion test, a photograph (b) after the adhesion test, and a binarized image (c) of the photograph after the adhesion test.

FIG. 12 is a photograph (a) of a measurement sample using an ultraviolet light-emitting body produced in Production example 3 before an adhesion test, a photograph (b) after the adhesion test, and a binarized image (c) of the photograph after the adhesion test.

FIG. 13 is a photograph (a) of a measurement sample using an ultraviolet light-emitting body produced in Production example 7 before an adhesion test, a photograph (b) after the adhesion test, and a binarized image (c) of the photograph after the adhesion test.

FIG. 14 is a photograph (a) of a measurement sample using an ultraviolet light-emitting body produced in Production example 11 before an adhesion test, a photograph (b) after the adhesion test, and a binarized image (c) of the photograph after the adhesion test.

FIG. 15 is a photograph (a) of a measurement sample using an ultraviolet light-emitting body produced in Production example 12 before an adhesion test, a photograph (b) after the adhesion test, and a binarized image (c) of the photograph after the adhesion test.

FIG. 16 is a PL spectrum of the measurement sample after the adhesion test of each of the ultraviolet light-emitting bodies produced in Production examples 1 to 3 and 7.

FIG. 17 is an X-ray diffraction pattern of each of the ultraviolet light-emitting bodies produced in Production examples 1, 2, and 11.

### DESCRIPTION OF EMBODIMENTS

Hereinafter, embodiments of the present invention will be described in detail with reference to the drawings as appropriate. The present invention is not limited to the following embodiments. In addition, in the description of the drawings, the same elements are designated by the same reference numerals, and redundant description will be omitted.

A production method for an ultraviolet light-emitting body containing Sc:YPO₄ crystal particles according to an embodiment of the present invention contains a step (hereinafter, also referred to as a “first step”) of subjecting a raw material to a hydrothermal reaction to obtain a precursor, the raw material containing a Sc source, a Y source, and a PO₄ source, and a step (hereinafter, also referred to as a “second step”) of firing the precursor.

The Sc source contained in the raw material used in the first step may be any substance containing Sc (scandium) as a constituent element, and may be Sc alone or a compound containing Sc as a constituent element. Examples of the compound containing Sc as a constituent element include an oxide of Sc. The oxide of Sc may be, for example, Sc₂O₃.

The Y source contained in the raw material used in the first step may be any substance containing Y (yttrium) as a constituent element, and may be Y alone or a compound containing Y as a constituent element.

Examples of the compound containing Y as a constituent element include an oxide and a nitrate of Y. The oxide of Y may be, for example, Y₂O₃. The nitrate of Y may be, for example, Y(NO₃)₃.

A molar ratio of Sc to Y (Sc/Y) in the raw material may be, for example, 1/99 or more, 2/98 or more, or 3/97 or more, and may be 40/60 or less, 20/80 or less, 10/90 or less, or 6/94 or less. Contents of the Sc source and the Y source in the raw material are adjusted so that a molar ratio of Sc to Y (Sc/Y) is within the above numerical range.

A PO₄ source contained in the raw material used in the first step may be any compound having a PO₄ structure. Examples of the compound having a PO₄ structure include H₃PO₄ (phosphoric acid) and phosphates. Examples of the phosphates include NH₄H₂PO₄ and (NH₄)₂HPO₄.

A content of PO₄ in the raw material may be 1 mol or more, 1.1 mol or more, 1.2 mol or more, or 1.3 mol or more, and may be 1.5 mol or less or 1.4 mol or less, with respect to the total 1 mol of the Y content (mol) and the Sc content (mol) in the raw material. The content of the PO₄ source in the raw material is adjusted so that the content of PO₄ is within the above numerical range.

The raw material may further contain Li₂CO₃. When the raw material further contains Li₂CO₃, the average particle size of Sc:YPO₄ crystal particles can be made smaller. A blending amount of Li₂CO₃ may be 0.10 parts by mass or more, 0.20 parts by mass or more, 0.30 parts by mass or more, or 0.36 parts by mass or more and may be 4.00 parts by mass or less, 3.50 parts by mass or less, or 3.00 parts by mass or less, with respect to 100 parts by mass of the sum of the theoretical yield of Sc:YPO₄ and the blending amount of Li₂CO₃.

The raw material may contain an additional component other than those described above. Examples of the additional component include a component containing an element other than Sc that can serve as an activator. Examples of such a component include a Bi (bismuth) source. The additional component may be an alkali metal element source other than Li₂CO₃. Examples of the alkali metal element source include a Li source such as LiF (excluding Li₂CO₃), a Na source such as NaF, and a K source such as KF.

In the first step, a precursor is obtained by subjecting the raw material described above to a hydrothermal reaction. Examples of a method for subjecting the raw material to a hydrothermal reaction include a method in which the raw material is mixed together with water (H₂O) in a reaction container and then heated while the reaction container is placed in a closed space.

A blending amount of water may be such that a mixture of the raw material and water becomes acidic, preferably such that a pH of the mixture becomes 1 or less. The blending amount of water may be, for example, 1000 parts by mass or more and 5000 parts by mass or less, with respect to 100 parts by mass of a total amount of the raw material.

A heating temperature during the hydrothermal reaction is preferably 130° C. or higher, more preferably 150° C. or higher, even more preferably 180° C. or higher, particularly preferably 200° C. or higher from the viewpoint that the average particle size of the Sc:YPO₄ crystal particles becomes smaller and an ultraviolet light-emitting body with better adhesion can be obtained, and may be, for example, 300° C. or lower, 250° C. or lower, or 230° C. or lower.

A pressure inside the reaction container during the hydrothermal reaction may be 0.1 MPa or more, 0.3 MPa or more, or 0.5 MPa or more. An upper limit of the pressure is not particularly limited as long as it is a pressure that the reaction container can withstand, and the pressure may be, for example, 2.8 MPa or less, 2.5 MPa or less, 2.2 MPa or less, or 1.9 MPa or less.

A reaction time of the hydrothermal reaction may be, for example, 10 hours or more and 30 hours or less. An atmosphere in which the hydrothermal reaction is performed may be, for example, an atmospheric atmosphere.

A material of the reaction container may be any material as long as it can withstand an environment of the hydrothermal reaction (has excellent chemical resistance, heat resistance, and pressure resistance), and may be, for example, Teflon (registered trademark). The reaction container is placed in a closed space, for example, in a sealable stainless steel container.

In the second step, the precursor obtained in the first step is fired. A firing temperature of the precursor is preferably 1100° C. or higher, more preferably 1200° C. or higher from the viewpoint that the average particle size of the Sc:YPO₄ crystal particles becomes smaller and an ultraviolet light-emitting body with better adhesion can be obtained, and may be 1700° C. or less, 1600° C. or less, 1500° C. or less, or 1400° C. or less.

A firing time may be, for example, 2 hours or more and 5 hours or less. A firing atmosphere may be, for example, an atmospheric atmosphere.

The production method of this embodiment may further contain a step of evaporating and removing a liquid such as water by heating a mixture containing the precursor produced in the first step between the first step and the second step.

According to the production method described above, an ultraviolet light-emitting body containing Sc:YPO₄ crystal particles can be produced, and also the average particle size of the Sc:YPO₄ crystal particles is smaller than the average particle size of the Sc:YPO₄ crystal particles obtained by a liquid phase method or a solid phase method. That is, another embodiment of the present invention is an ultraviolet light-emitting body containing Sc:YPO₄ crystal particles in which the average particle size of the Sc:YPO₄ crystal particles is 5.10 μm or less. The fact that the ultraviolet light-emitting body contains the Sc:YPO₄ crystals can be confirmed by X-ray diffraction measurement using CuKα rays (wavelength: 1.54 Å). The ultraviolet light-emitting body (the ultraviolet light-emitting body obtained by the above-described production method using a hydrothermal reaction) has excellent adhesion to the substrate compared to the ultraviolet light-emitting body obtained by a liquid phase method or a solid phase method.

The Sc:YPO₄ crystal particles constituting the ultraviolet light-emitting body may contain only Sc, Y, and PO₄ as constituent elements, or may further contain an additional constituent element. The additional constituent element may be, for example, Li. That is, in one embodiment, the Sc:YPO₄ crystal particles may contain Li. The Sc:YPO₄ crystal particles containing Li are obtained, for example, when the raw material contains Li₂CO₃ in the first step described above. In this case, in the above production method, since Li₂CO₃ is not used as a flux and is not removed during a producing process, Li remains in the Sc:YPO₄ crystal particles even after the second step (firing). The fact that the Sc:YPO₄ crystal particles contain Li can be confirmed by high-frequency inductively coupled plasma emission spectroscopy (ICP-AES).

In one embodiment, the ultraviolet light-emitting body is a powder composed of Sc:YPO₄ crystal particles (an aggregate of Sc:YPO₄ crystal particles). In one embodiment, the ultraviolet light-emitting body may be composed only of Sc:YPO₄ crystal particles (Sc:YPO₄ crystal particles containing Li) and unavoidable impurities, and may be composed only of Sc:YPO₄ crystal particles (Sc:YPO₄ crystal particles containing Li).

An average particle size of the ultraviolet light-emitting body may be 5.00 μm or less, 4.50 μm or less, or 4.00 μm or less, and may be 1.00 μm or more, 1.50 μm or more, 2.00 μm or more, 2.50 μm or more, or 3.00 μm or more. In this specification, the average particle size of the ultraviolet light-emitting body is determined by measuring the particle size distribution using a laser diffraction/scattering method and is defined as the particle diameter (D₅₀) at which the cumulative value in the volume-based cumulative particle size distribution is 50%.

The ultraviolet light-emitting body is excited by irradiation with excitation light (light with a shorter wavelength than a wavelength of light emitted by the ultraviolet light-emitting body) or an electron beam, and emits ultraviolet light. An emission peak wavelength may be, for example, 230 nm or more and 240 nm or less.

The above-described ultraviolet light-emitting body can be used, for example, in ultraviolet light sources. An ultraviolet light source according to an embodiment of the present invention contains the above-described ultraviolet light-emitting body and an electron beam source that irradiates the ultraviolet light-emitting body with an electron beam.

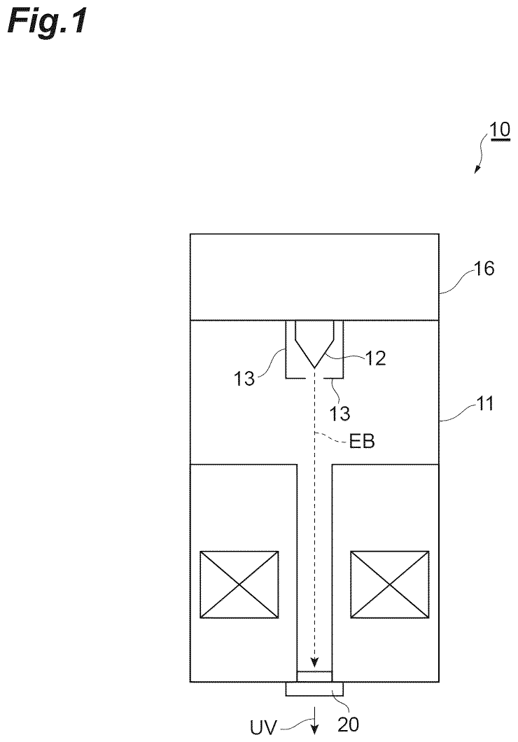

FIG. 1 is a schematic view showing an internal configuration of an electron beam excitation type ultraviolet light source according to an embodiment. As shown in FIG. 1, in this ultraviolet light source 10, an electron source 12 and an extraction electrode 13 are disposed on the upper end side inside an evacuated container (an electron tube) 11. When an appropriate extraction voltage is applied from a power supply part 16 between the electron source 12 and the extraction electrode 13, an electron beam EB accelerated by a high voltage is emitted from the electron source 12. As the electron source 12, for example, an electron source (for example, a cold cathode such as a carbon nanotube, or a hot cathode) that emits a large-area electron beam is used.

Further, an ultraviolet light generation target 20 is disposed on the lower end side inside of the container 11. The ultraviolet light generation target 20 is set to, for example, a ground potential, and a negative high voltage is applied to the electron source 12 from the power supply part 16. Thus, the electron beam EB emitted from the electron source 12 is radiated onto the ultraviolet light generation target 20. The ultraviolet light generation target 20 is excited by receiving the electron beam EB and generates ultraviolet light UV.

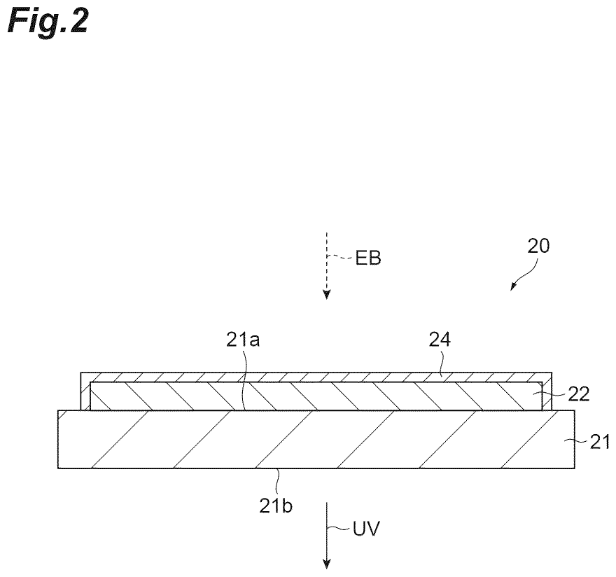

FIG. 2 is a cross-sectional view showing a configuration of the ultraviolet light generation target 20. As shown in FIG. 2, the ultraviolet light generation target 20 contains a substrate 21, a layered ultraviolet light-emitting body 22 provided on the substrate 21, and a light reflecting film 24 provided on the ultraviolet light-emitting body 22. The substrate 21 is a plate-shaped member made of a material that transmits ultraviolet light UV. The substrate 21 may be made of sapphire (Al₂O₃), for example. The substrate 21 has a main surface 21a and a back surface 21b. A thickness of the substrate 21 may be, for example, 0.1 mm or more and 10 mm or less.

The ultraviolet light-emitting body 22 is in contact with the main surface 21a of the substrate 21 and is excited by receiving the electron beam EB and generates the ultraviolet light UV. The ultraviolet light-emitting body 22 is the ultraviolet light-emitting body as described above.

The light reflecting film 24 contains, for example, a metal material such as aluminum. The light reflecting film 24 completely covers an upper surface and side surfaces of the ultraviolet light-emitting body 22. Of the ultraviolet light UV generated by the ultraviolet light-emitting body 22, the light traveling in a direction opposite to the substrate 21 is reflected by the light reflecting film 24 and travels toward the substrate 21.

In the ultraviolet light generation target 20, when the electron beam EB emitted from the electron source 12 (refer to FIG. 1) is incident on the ultraviolet light-emitting body 22, the ultraviolet light-emitting body 22 is excited and the ultraviolet light UV is generated. Some of the ultraviolet light UV directly travels toward the main surface 21a of the substrate 21, and the remaining of the ultraviolet light UV is reflected by the light reflecting film 24 and then travels toward the main surface 21a of the substrate 21. Then, the ultraviolet light UV is incident on the main surface 21a, passes through the substrate 21, and is then emitted to the outside from the back surface 21b.

An ultraviolet light source according to another embodiment of the present invention contains the above-described ultraviolet light-emitting body and a light source that radiates excitation light onto the ultraviolet light-emitting body.

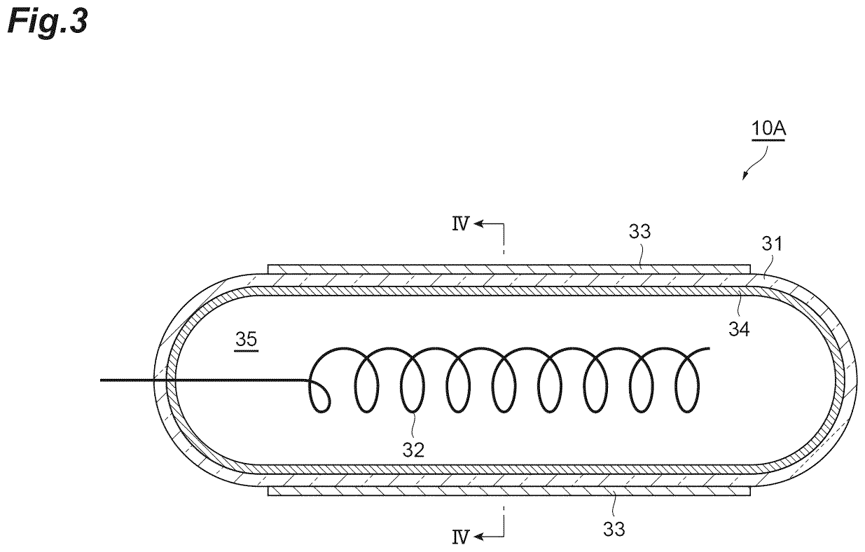

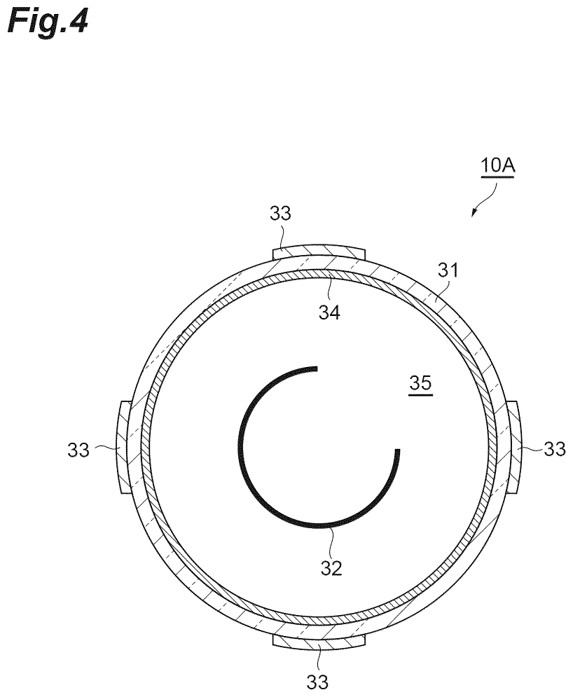

FIG. 3 is a cross-sectional view showing an internal configuration of a photo-excitation type ultraviolet light source according to an embodiment, and shows a cross section containing a central axis. FIG. 4 is a cross-sectional view of an ultraviolet light source 10A shown in FIG. 3 along line IV-IV, and shows a cross section perpendicular to the central axis. As shown in FIGS. 3 and 4, the ultraviolet light source 10A contains an evacuated container 31, an electrode 32 disposed inside the container 31, a plurality of electrodes 33 disposed outside the container 31, and an ultraviolet light-emitting body 34 disposed on an inner surface of the container 31 to generate ultraviolet light.

The container 31 has a substantially cylindrical shape, one end and the other end of the container 31 in a direction of a central axis thereof are closed in a hemispherical shape, and an internal space 35 of the container 31 is airtightly sealed. A constituent material of the container 31 is, for example, quartz glass. The constituent material of the container 31 is not limited to the quartz glass as long as it is a material that transmits the ultraviolet light output from the ultraviolet light-emitting body 34. The internal space 35 is filled with, for example, xenon (Xe) as a discharge gas.

The electrode 32 is, for example, a metal filament, and is introduced into the internal space 35 from the outside of the container 31. In the example shown in FIGS. 3 and 4, the electrode 32 is helically bent and extends from a position near one end of the container 31 to a position near the other end thereof in the internal space 35. As shown in FIG. 4, the electrode 32 is disposed at the center of the internal space 35 in a cross section perpendicular to the central axis of the container 31. Each of the electrodes 33 is, for example, a metal film that is in close contact with an outer wall surface of the container 31. In the example shown in FIGS. 3 and 4, four electrodes 33 are provided. Each of the four electrodes 33 extends in the direction of the central axis of the container 31, and is arranged at equal intervals in a circumferential direction of the container 31.

A high-frequency voltage is applied between the electrode 32 and the electrodes 33, and discharge plasma is formed in a space between the electrode 32 and the electrodes 33, that is, the internal space 35 of the container 31. As described above, since the internal space 35 is filled with the discharge gas, when discharge plasma is generated, the discharge gas performs excimer light emission to generate vacuum ultraviolet light. When the discharge gas is Xe, a wavelength of the generated vacuum ultraviolet light is 172 nm.

The ultraviolet light-emitting body 34 is disposed in a film shape over the entire inner wall surface of the container 31. The ultraviolet light-emitting body 34 is the ultraviolet light-emitting body as described above. The ultraviolet light-emitting body 34 is excited by the vacuum ultraviolet light generated in the internal space 35, and generates ultraviolet light having a longer wavelength (for example, 233 nm) than the vacuum ultraviolet light. The ultraviolet light generated by the ultraviolet light-emitting body 34 passes through the container 31 and is output to the outside of the container 31 through gaps between the plurality of electrodes 33. A thickness of the ultraviolet light-emitting body 34 may be, for example, 0.1 μm or more and 1 mm or less.

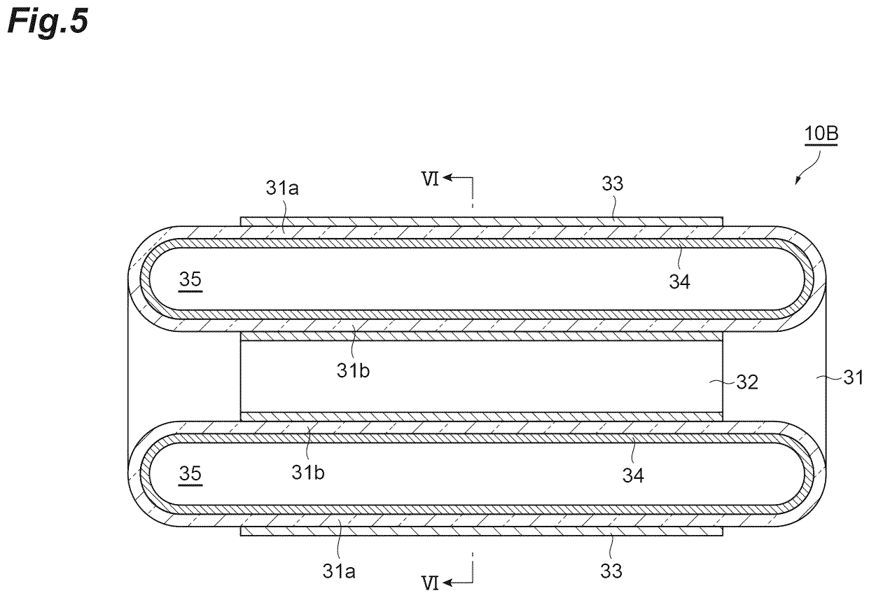

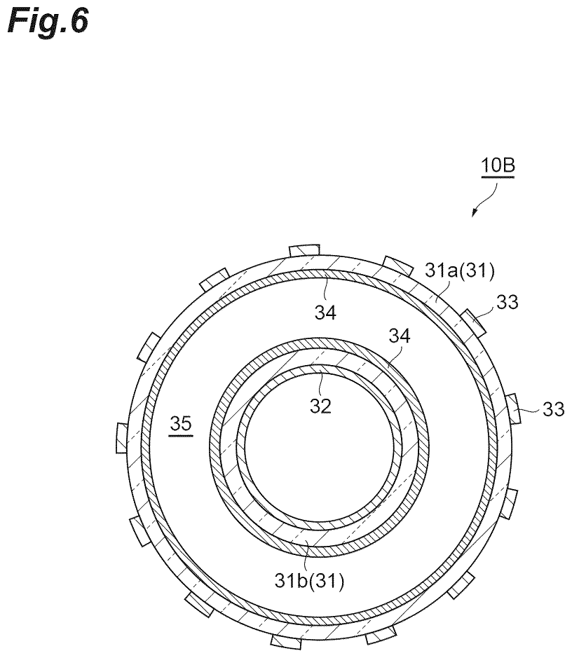

FIG. 5 is a cross-sectional view showing a configuration of another ultraviolet light source 10B, and shows a cross section containing the central axis. FIG. 6 is a cross-sectional view of the ultraviolet light source 10B shown in FIG. 5 along line VI-VI, and shows a cross section perpendicular to a central axis. As shown in FIGS. 5 and 6, the ultraviolet light source 10B contains a container 31, an electrode 32, a plurality of electrodes 33, and an ultraviolet light-emitting body 34. A difference between the ultraviolet light source 10B and the ultraviolet light source 10A described above is shapes of the container 31 and the electrode 32.

The container 31 of the ultraviolet light source 10B has a double cylindrical shape and contains an outer cylindrical part 31a and an inner cylindrical part 31b. A gap between the inner cylindrical part 31b and the outer cylindrical part 31a is closed at both ends of the container 31 in a direction of the central axis, and constitutes an airtightly sealed internal space 35. Further, the electrode 32 is disposed inside the inner cylindrical part 31b. For example, the electrode 32 is a metal film formed on an inner wall surface of the inner cylindrical part 31b. The electrode 32 extends from a position near one end of the inner cylindrical part 31b to a position near the other end thereof.

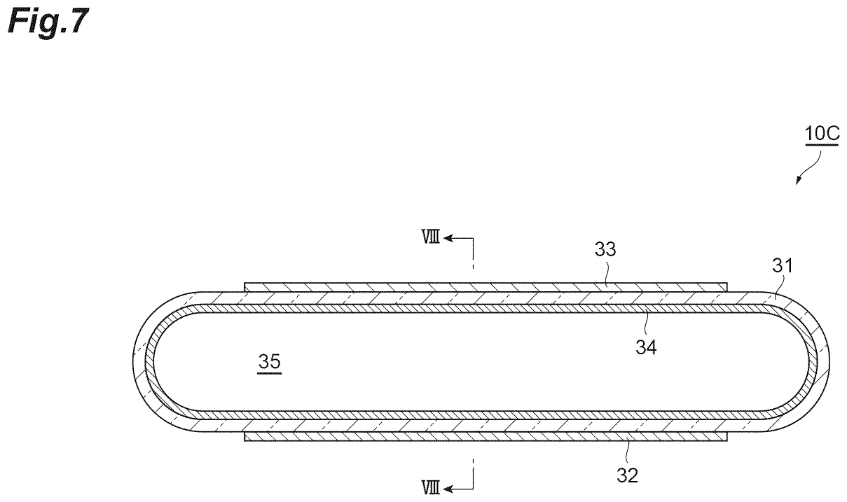

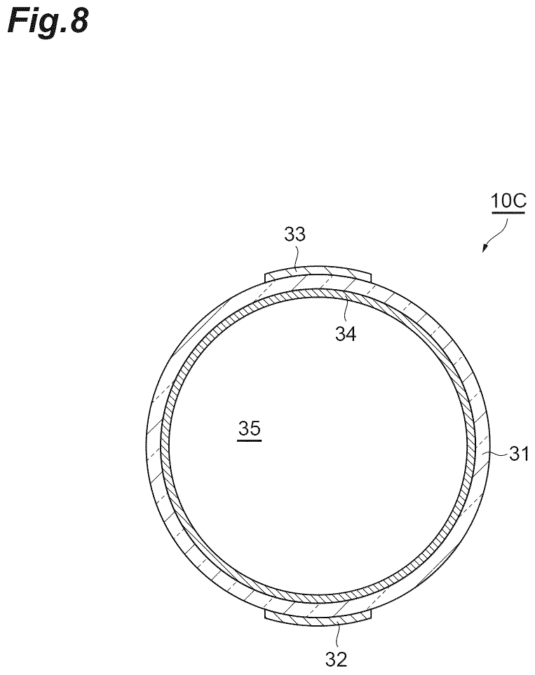

FIG. 7 is a cross-sectional view showing a configuration of another ultraviolet light source 10C, and shows a cross section containing the central axis. FIG. 8 is a cross-sectional view of the ultraviolet light source 10C shown in FIG. 7 along line VIII-VIII, and shows a cross section perpendicular to the central axis. As shown in FIGS. 7 and 8, the ultraviolet light source 10C contains a container 31, an electrode 32, an electrode 33, and an ultraviolet light-emitting body 34. A difference between the ultraviolet light source 10C and the ultraviolet light source 10A described above is modes of the electrodes 32 and 33.

The electrode 32 of the ultraviolet light source 10C is disposed outside the cylindrical container 31. In one example, the electrode 32 is a metal film formed on an outer wall surface of the container 31. Further, the electrode 33 is disposed at a position facing the electrode 32 with the central axis interposed therebetween on the outer wall surface of the container 31. The electrodes 32 and 33 extend in a direction of the central axis.

Also in the ultraviolet light sources 10B and 10C described above, when a high voltage is applied between the electrodes 32 and 33, discharge plasma is formed in an internal space 35 of the container 31. Then, the discharge gas performs excimer light emission to generate vacuum ultraviolet light. The ultraviolet light-emitting body 34 is excited by the vacuum ultraviolet light (excitation light) generated in the internal space 35, and generates ultraviolet light with a longer wavelength than a wavelength of the vacuum ultraviolet light. The ultraviolet light generated by the ultraviolet light-emitting body 34 passes through the outer cylindrical part 31a of the container 31 and is output to the outside of the container 31 through gaps between the plurality of electrodes 33 or gaps between the electrodes 32 and 33.

When the ultraviolet light-emitting body is disposed in a layered manner on the substrate 21 (in the case of the ultraviolet light-emitting body 22) or disposed in a layered manner on the inner wall surface of the container 31 (in the case of the ultraviolet light-emitting body 34), although the powdered ultraviolet light-emitting body may be placed directly on the substrate 21 or the inner wall surface of the container 31, a sedimentation method may also be used. The sedimentation method is a method in which a powdered ultraviolet light-emitting body is put into a liquid such as alcohol, and the ultraviolet light-emitting body is dispersed in the liquid using ultrasonic waves or the like, and the ultraviolet light-emitting body is naturally settled on the substrate 21 or the inner wall surface of the container 31 disposed at the bottom of the liquid, and then dried. By using such a method, the ultraviolet light-emitting body can be deposited on the substrate 21 or the inner wall surface of the container 31 with a uniform density and thickness. In this way, the ultraviolet light-emitting body 22 is formed on the substrate 21 or the ultraviolet light-emitting body 34 is formed on the inner wall surface of the container 31.

After the ultraviolet light-emitting body is disposed in a layered manner on the substrate 21 (in the case of the ultraviolet light-emitting body 22) or disposed in a layered manner on the inner wall surface of the container 31 (in the case of the ultraviolet light-emitting body 34) as described above, the firing (heat treatment) of the ultraviolet light-emitting body 34 may be performed again. The firing is performed in the atmosphere for the purpose of sufficiently evaporating the alcohol, and for the purpose of increasing an adhesion force between the substrate 21 or the container 31 and the crystals, and an adhesion force between the crystals. A firing temperature at this time is, for example, 1100° C., and a firing time is, for example, 2 hours.

When an ultraviolet light generation target 20 is produced, after the above steps, a light reflecting film 24 is formed to cover an upper surface and side surfaces of the ultraviolet light-emitting body 22. A method for forming the light reflecting film 24 is, for example, vacuum deposition. A thickness of the light reflecting film 24 on the upper surface of the ultraviolet light-emitting body 22 is, for example, 50 nm.

In the above explanation, although the ultraviolet light-emitting body obtained by firing a precursor is deposited on the inner wall surface of the container 31, the precursor before firing may be deposited on the inner wall surface of the container 31, and then the precursor may be fired (that is, the second step described above). In this case, the mixture may be deposited on the inner wall surface of the container 31 by the above-described sedimentation method, or a method in which the mixture is mixed with an organic material as a binder, applied, and then the organic material is removed by firing may be used.

### EXAMPLES

Hereinafter, the present invention will be explained in more detail based on examples, but the present invention is not limited to the examples at all.

### [Preparation of Ultraviolet Light-Emitting Body by Hydrothermal Synthesis Method]

### Production Example 1

An ultraviolet light-emitting body was produced by a method using a hydrothermal reaction (also referred to as a “hydrothermal synthesis method”). Specifically, first, 3.7346 g of Y₂O₃ (manufactured by Shin-Etsu Chemical Co., Ltd., 99.9%), 0.1200 g of Sc₂O₃ (manufactured by Kojundo Kagaku Kenkyusho Co., Ltd., 99.9%), 0.0226 g (an amount that is 0.36 parts by mass with respect to 100 parts by mass of the sum of the theoretical yield of Sc:YPO₄ and the blended amount of Li₂CO₃) of Li₂CO₃ (manufactured by Alfa Aesar, 99.998%), 2.8 ml of H₃PO₄ (manufactured by Fuji Film Wako Pure Chemical Corporation, 85%) and 80 ml of pure water were put in a Teflon (registered trademark) container, covered with a lid, and stirred for 1 hour at room temperature (20° C.) using a magnetic stirrer (300 rpm) to obtain a liquid mixture. The pH of this liquid mixture was 1. Then, the Teflon (registered trademark) container was put in a stainless steel container, sealed, and heated in an electric furnace at 210° C. (a heating temperature during the hydrothermal reaction) and a pressure of about 1.8 MPa inside the container for 24 hours to obtain a mixture of a powdered precursor and a liquid. After the obtained mixture was cooled to room temperature, the mixture was transferred to a beaker and heated on a hot plate (90° C.) to evaporate the liquid and the precursor was collected. The obtained precursor was transferred to an alumina boat and fired with an electric furnace at 1200° C. (a firing temperature) for 2 hours in the atmospheric atmosphere to obtain an ultraviolet light-emitting body according to Production example 1.

### Production Examples 2 to 8

Each of ultraviolet light-emitting bodies according to Production examples 2 to 8 was obtained in the same manner as Production example 1, except that at least one of the blending amount of Li₂CO₃, the heating temperature during the hydrothermal reaction, and the firing temperature was changed as shown in Table 1. In Production example 3, the pressure inside the container when heated at 150° C. was about 0.49 MPa.

### Production Example 9

An ultraviolet light-emitting body according to Production example 9 was obtained in the same manner as Production example 1 except that Li₂CO₃ was not blended.

### [Production of Ultraviolet Light-Emitting Body by Liquid Phase Method]

### Production Example 10

The ultraviolet light-emitting body was produced by a conventional liquid phase method. Specifically, first, 16.3454 g of Y₂O₃, 0.5254 g of Sc₂O₃, 11.0 ml of H₃PO₄, and 1800 ml of pure water were put in a beaker and stirred at room temperature (20° C.) for 24 hours using a magnetic stirrer (300 rpm). Then, the mixture was heated while stirring to evaporate the liquid to obtain a powdered mixture 1. 4.1084 g of the obtained mixture 1 was weighed out, 0.0147 g (an amount that is 0.36 parts by mass with respect to 100 parts by mass of the sum of the theoretical yield of Sc:YPO₄ and the blended amount of Li₂CO₃) of Li₂CO₃ and 10 ml of ethanol were added, and the mixture was wet-mixed in an agate mortar to obtain a mixture 2. Then, the mixture 2 was put in an alumina boat and fired with an electric furnace at 1200° C. (the firing temperature) for 2 hours to obtain an ultraviolet light-emitting body according to Production example 10.

### Production Example 11

An ultraviolet light-emitting body according to Production example 11 was obtained in the same manner as Production example 10 except that the firing temperature was changed to 1600° C.

### [Preparation of Ultraviolet Light-Emitting Body by Solid Phase Method]

### Production Example 12

An ultraviolet light-emitting body was produced by a conventional solid phase method. Specifically, first, 1.0032 g of Y₂O₃, 0.0321 g of Sc₂O₃, 1.0729 g of NH₄H₂PO₄ (manufactured by Kanto Kagaku Co., Ltd., 99.0%), 0.0062 g (an amount that is 0.36 parts by mass with respect to 100 parts by mass of the sum of the theoretical yield of Sc:YPO₄ and the blended amount of Li₂CO₃) of Li₂CO₃ and about 10 ml of ethanol were wet-mixed in an agate mortar. Then, the powder was put in an alumina boat and fired with an electric furnace at 1600° C. (the firing temperature) for 2 hours to obtain an ultraviolet light-emitting body according to Production example 12.

### [Particle Size Distribution Measurement]

For the ultraviolet light-emitting bodies of Production examples 1 to 12, a volume-based particle size distribution was measured by a laser diffraction/scattering method using HORIBA LA-920 (manufactured by Horiba, Ltd.), and an average particle size (D₅₀) was obtained. Specifically, first, ion-exchanged water (approximately 150 mL) was introduced as a dispersion medium for the powder and circulated within the apparatus, air was removed, and then a transmittance in a blank state was measured. Next, the ultraviolet light-emitting body (an amount that gives a transmittance of 75% to 95%) was introduced, and ultrasonic waves were applied to uniformly disperse it, and the particle size distribution was measured while the ultraviolet light-emitting body dispersion was circulating in the apparatus. A He—Ne laser was used as a laser. After the measurement was completed, the water was drained and the ion-exchanged water was added several times to wash away the sample after measurement, and then the next sample was measured. The results are shown in Table 1.

TABLE 1

| | Production | Production | Production | Production |
|---|---|---|---|---|
| | example 1 | example 2 | example 3 | example 4 |
| Production | Hydrothermal synthesis method | | | |
| method | | | | |
| Blending | 0.36 | 0.36 | 0.36 | 0.14 |
| amount of | | | | |
| Li₂CO₃ | | | | |
| (parts by mass) | | | | |
| Heating | 210 | 210 | 150 | 210 |
| temperature | | | | |
| during the | | | | |
| hydrothermal | | | | |
| reaction | | | | |
| (° C.) | | | | |
| Firing | 1200 | 1600 | 1200 | 1600 |
| temperature | | | | |
| (° C.) | | | | |
| Average particle | 3.43 | 3.47 | 3.72 | 4.22 |
| size (μm) | | | | |
| | Production | Production | Production | Production |
| | example 5 | example 6 | example 7 | example 8 |
| Production | Hydrothermal synthesis method | | | |
| method | | | | |
| Blending | 0.71 | 0.71 | 1.42 | 1.42 |
| amount of | | | | |
| Li₂CO₃ | | | | |
| (parts by mass) | | | | |
| Heating | 210 | 210 | 210 | 210 |
| temperature | | | | |
| during the | | | | |
| hydrothermal | | | | |
| reaction | | | | |
| (° C.) | | | | |
| Firing | 1200 | 1600 | 1200 | 1600 |
| temperature | | | | |
| (° C.) | | | | |
| Average particle | 3.87 | 3.47 | 5.05 | 3.63 |
| size (μm) | | | | |

| | Production | Production | Production | Production |
|---|---|---|---|---|
| | example 9 | example 10 | example 11 | example 12 |
| Production | Hydrothermal | liquid phase method | | Solid phase |
| method | synthesis | | | method |
| | method | | | |
| Blending | — | 0.36 | 0.36 | 0.36 |
| amount of | | | | |
| Li₂CO₃ | | | | |
| (parts by | | | | |
| mass) | | | | |
| Heating | 210 | — | — | — |
| temperature | | | | |
| during the | | | | |
| hydrothermal | | | | |
| reaction | | | | |
| (° C.) | | | | |
| Firing | 1600 | 1200 | 1600 | 1600 |
| temperature | | | | |
| (° C.) | | | | |
| Average | 4.96 | 5.15 | 5.13 | 5.38 |
| particle size | | | | |
| (μm) | | | | |

As shown in Table 1, the average particle sizes of the ultraviolet light-emitting bodies produced by the hydrothermal synthesis method (Production examples 1 to 9) were smaller than those of the ultraviolet light-emitting bodies produced by the liquid phase method or the solid phase method (Production examples 10 to 12).

### [Observation by SEM]

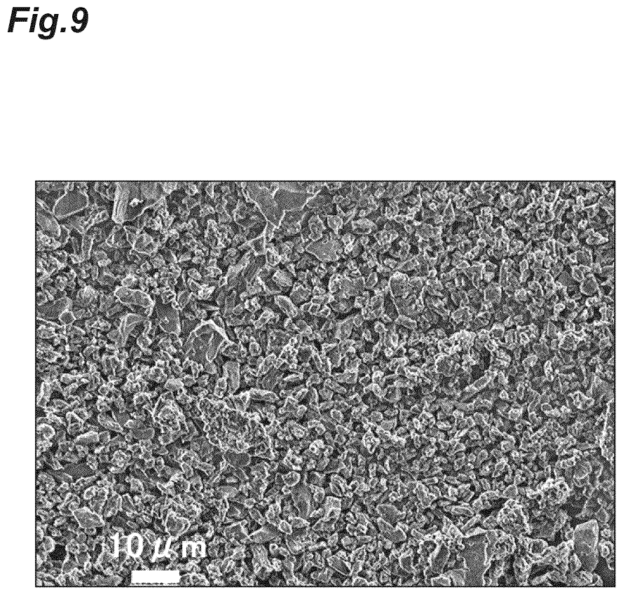

As a representative example, FIG. 9 shows an SEM image of the ultraviolet light-emitting body of Production example 1 observed using a scanning electron microscope (SEM).

### [Adhesion Test]

An adhesion of the ultraviolet light-emitting bodies of Production examples 1 to 3, 7, 11, and 12 was evaluated as follows.

In the ultraviolet light-emitting body after firing, since Sc:YPO₄ crystal particles aggregated and formed a lump, first, the ultraviolet light-emitting body of each of Production examples was loosened using an agate mortar and classified by sieving, and particles with a particle size of 20 μm or less were collected. The collected particles and 5 mL of a dispersion medium (acetone or ethanol) were put in a beaker and subjected to ultrasonication to prepare a dispersion of ultraviolet light-emitting body particles. Next, a tube (made of SUS304) was placed on a quartz substrate of φ12 mm×t2 mm through silicone rubber with a hole (φ8 mm), and the prepared dispersion was poured through the tube, and the crystal particles were settled on the quartz substrate (a hole portion in the silicone rubber). Then, the dispersion was left in the atmosphere at room temperature until the dispersion medium was evaporated. Then, the crystal particles deposited on the quartz substrate were fired at 1100° C. for 2 hours in the atmospheric atmosphere to produce a measurement sample.

Subsequently, using a digital camera (manufactured by RICOH Company), a surface of the measurement sample coated with the ultraviolet light-emitting body was photographed from directly above. Next, an adhesive portion of a sticky note (“Post-it 500RP-PN” manufactured by 3M Japan Co., Ltd.) was attached on a surface of the applied ultraviolet light-emitting body, and a 1 kg weight was placed thereon via silicone rubber of @20 mm×t3 mm. After 1 minute, the weight and the silicone rubber were removed, and the sticky note was slowly peeled off in a direction of 90° from the surface coated with the ultraviolet light-emitting body using tweezers. After the sticky note was completely peeled off, the surface coated with the ultraviolet light-emitting body was photographed again from directly above.

Each of images taken before and after the adhesion test was binarized so that a portion in which the quartz plate was exposed was white and a portion in which the ultraviolet light-emitting body covered the quartz plate was black. From the processed image, a coating area A1 of the ultraviolet light-emitting body in the measurement sample before the adhesion test and a coating area A2 of the ultraviolet light-emitting body in the measurement sample after the adhesion test were calculated, and a coverage retention rate (%)=A2/A1×100 was determined.

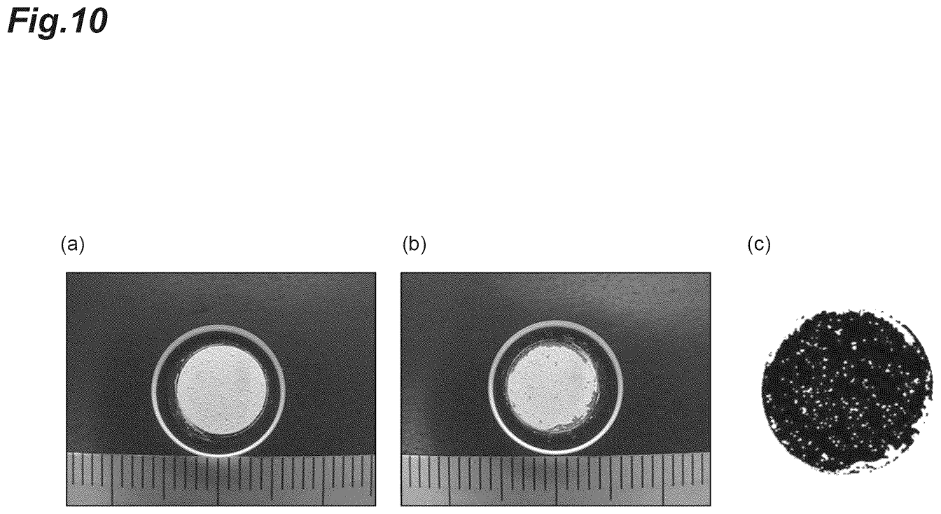

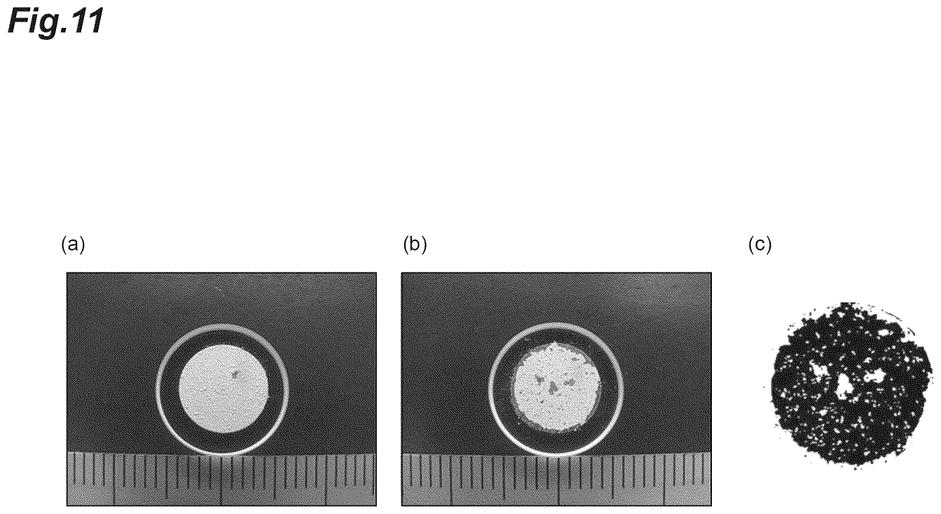

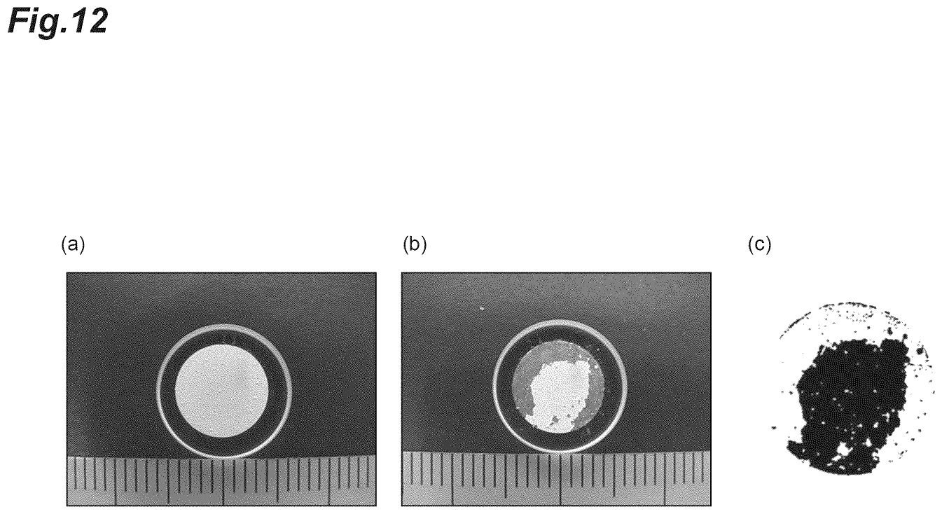

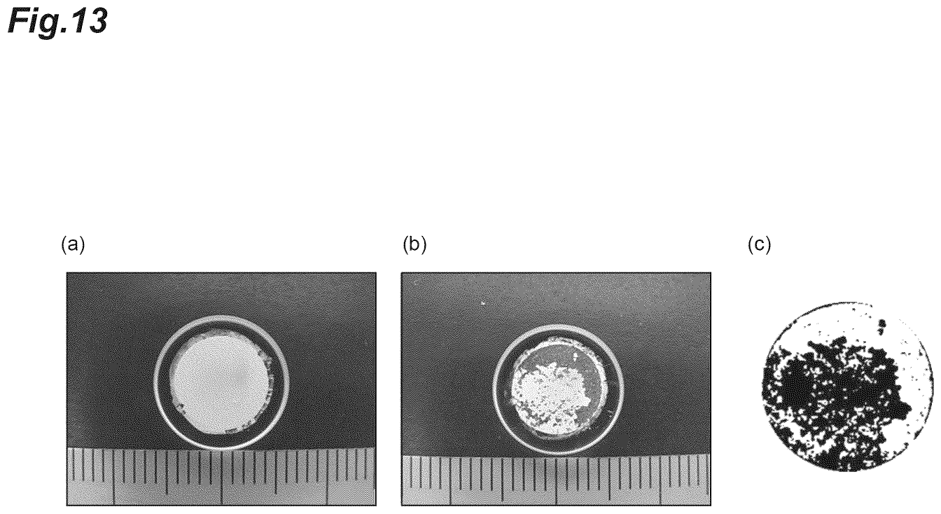

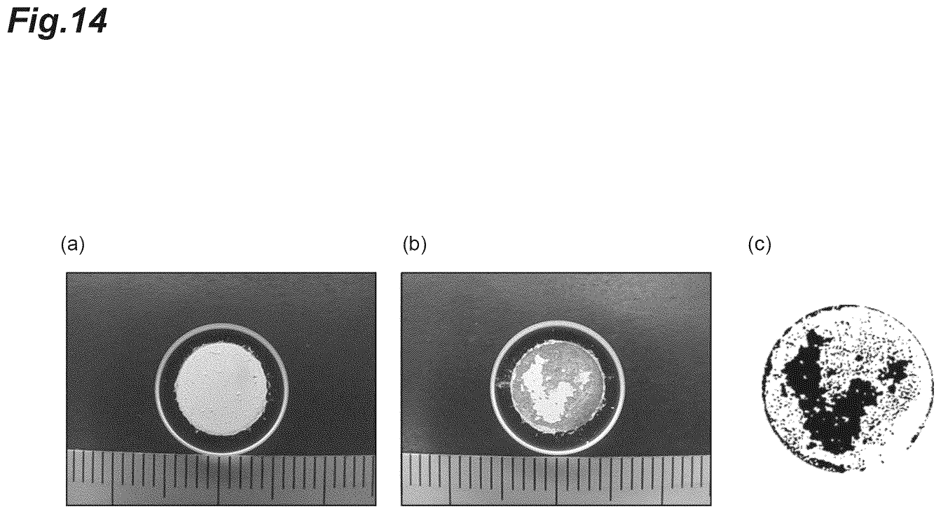

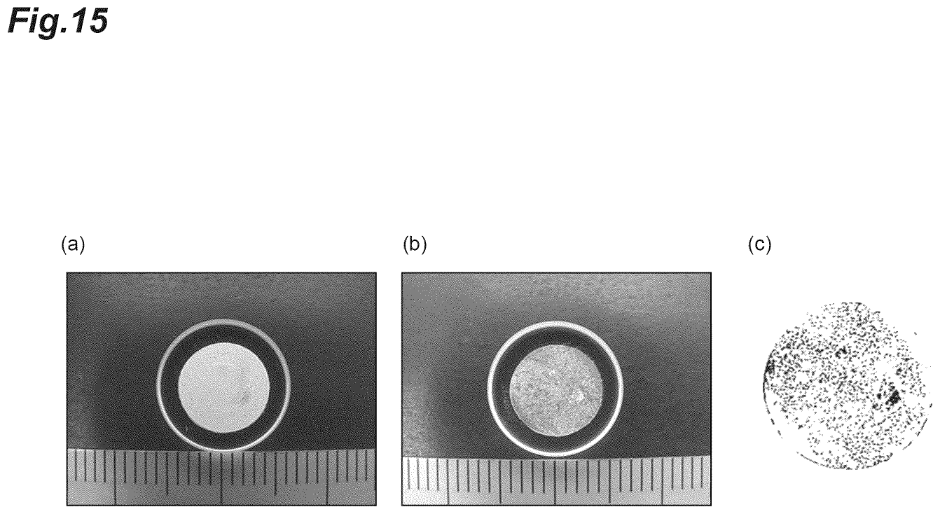

Regarding the measurement samples of the ultraviolet light-emitting bodies of Production examples 1 to 3, 7, 11, and 12, (a) an image taken before the adhesion test (an image before binarization processing), (b) an image taken after the adhesion test (an image before binarization processing) and (c) an image obtained by binarization processing of the image taken after the adhesion test are shown in FIGS. 10 to 15, respectively. Further, the calculated coverage retention rates are shown in Table 2.

TABLE 2

| | Production | Production | Production |
|---|---|---|---|
| | example 1 | example 2 | example 3 |
| Average particle | 3.43 | 3.47 | 3.72 |
| size (μm) | | | |
| coverage retention | 86.1 | 76.7 | 52.7 |
| rate before and after | | | |
| adhesion test (%) | | | |

| | Production | Production | Production |
|---|---|---|---|
| | example 7 | example 11 | example 12 |
| Average particle | 5.05 | 5.13 | 5.38 |
| size (μm) | | | |
| coverage retention | 53.9 | 39.6 | 16.7 |
| rate before and after | | | |
| adhesion test (%) | | | |

As shown in FIGS. 10 to 15 and Table 2, the ultraviolet light-emitting bodies of Production examples 1 to 3 and 7 had higher coverage retention rates before and after the adhesion test, and had excellent adhesion to the substrate, compared to the ultraviolet light-emitting bodies of Production examples 11 and 12.

### [Photo-Excitation Luminescence (PL) Measurement]

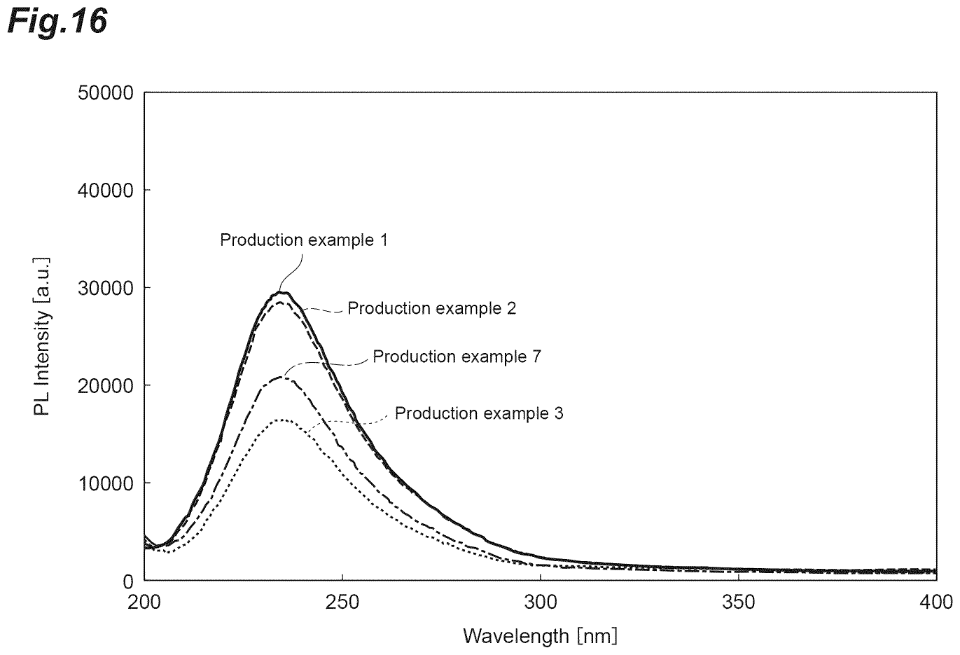

Photo-excitation luminescence (PL): measurements were performed on the measurement samples of the ultraviolet light-emitting bodies of Production examples 1 to 3 and 7 after the above-described adhesion test using a xenon excimer lamp (wavelength: 172 nm) as an excitation light source. FIG. 16 shows PL spectra of the measurement samples of Production examples.

### [X-Ray Diffraction (XRD) Measurement]

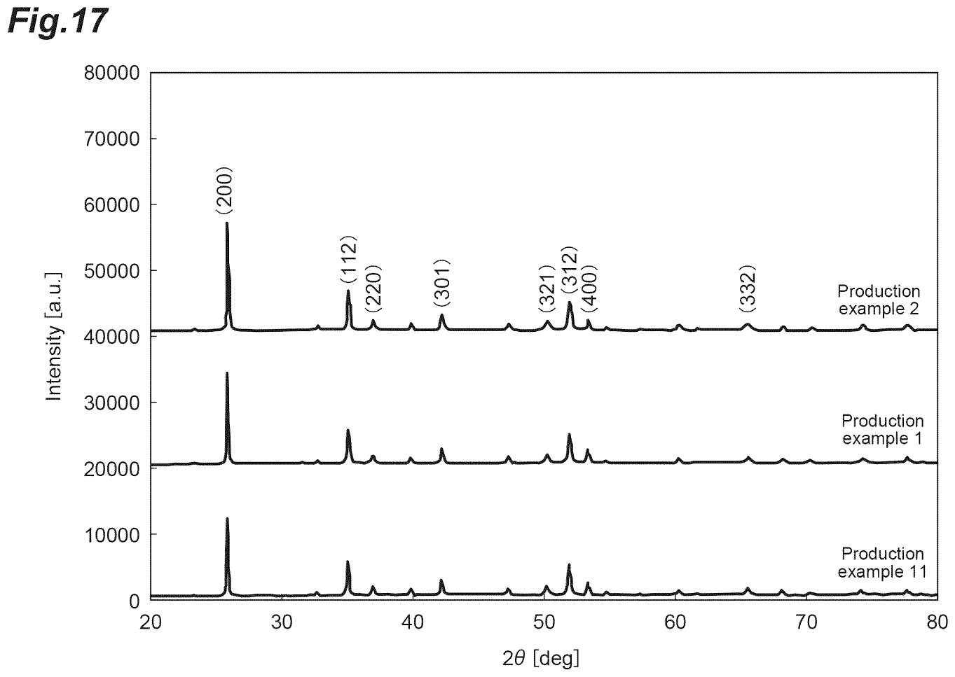

The ultraviolet light-emitting bodies of Production examples 1, 2, and 11 were subjected to X-ray diffraction measurements using CuKα rays (wavelength: 1.54 Å). FIG. 17 shows X-ray diffraction patterns of the ultraviolet light-emitting bodies of Production examples. The X-ray diffraction pattern of the ultraviolet light-emitting body of each of Production examples matched the X-ray diffraction pattern of YPO₄ (01-084-0335) in ICDD database.

### REFERENCE SIGNS LIST

10, 10A to 10C ultraviolet light source
11 Container
12 Electron source
13 Extraction electrode
16 Power supply part
20 ultraviolet light generation target
21 Substrate
21a Main surface
21b Back surface
22, 34 ultraviolet light-emitting body
24 Light reflecting film
31 Container
31a Outer cylindrical part
31b Inner cylindrical part
32, 33 Electrode
35 Internal space
EB Electron beam
UV Ultraviolet light

1. A production method for an ultraviolet light-emitting body comprising Sc:YPO₄ crystal particles, the method comprising:
subjecting a raw material to a hydrothermal reaction to obtain a precursor, the raw material comprising a Sc source, a Y source, and a PO₄ source; and
firing the precursor.

2. The production method according to claim 1, wherein the raw material further comprises Li₂CO₃.

3. The production method according to claim 2, wherein a blending amount of the Li₂CO₃ is 0.36 parts by mass or more with respect to 100 parts by mass of a sum of a theoretical yield of the Sc:YPO₄ and the blending amount of the Li₂CO₃.

4. The production method according to claim 1, wherein a heating temperature during the hydrothermal reaction of the raw material is 150° C. or higher.

5. An ultraviolet light-emitting body comprising Sc:YPO₄ crystal particles comprising Li, wherein an average particle size of the Sc:YPO₄ crystal particles is 5.10 μm or less.

6. An ultraviolet light source comprising:
the ultraviolet light-emitting body according to claim 5; and
a light source configured to irradiate the ultraviolet light-emitting body with excitation light having a shorter wavelength than a wavelength of light emitted by the ultraviolet light-emitting body.

7. An ultraviolet light source comprising:
the ultraviolet light-emitting body according to claim 5; and
an electron source configured to irradiate the ultraviolet light-emitting body with an electron beam.
